(19) United States
(12) Patent Application Publication
(10) Pub. No.: US 2026/0037831 A1
(43) Pub. Date: Feb. 5, 2026

(54) METHOD AND DEVICE WITH BAYESIAN META CONTINUAL-LEARNING AND INFERRING

(71) Applicants: Samsung Electronics Co., Ltd., Suwon-si (KR); Seoul National University R&DB Foundation, Seoul (KR)

(72) Inventors: Kikyung KIM, Suwon-si (KR); Gunhee KIM, Seoul (KR); Jaehyeon SON, Seoul (KR); Soochan LEE, Seoul (KR); Hyeonseong JEON, Seoul (KR); Chanho AHN, Suwon-si (KR); Seungju HAN, Suwon-si (KR)

(73) Assignees: Samsung Electronics Co., Ltd., Suwon-si (KR); Seoul National University R&DB Foundation, Seoul (KR)

(21) Appl. No.: 19/287,070

(22) Filed: Jul. 31, 2025

(30) Foreign Application Priority Data
Aug. 2, 2024 (KR) 10-2024-0103287

(51) Int. Cl. G06N 3/0985

(52) U.S. Cl. CPC G06N 3/0985

(57) ABSTRACT

A meta continual-learning and inferring method uses an implementation of Bayes' theorem, and includes: calculating a likelihood of learning data for a given latent variable by a data distribution learner; performing a sequential Bayesian update and calculating a final posterior distribution of the latent variable by using prior distribution of the latent variable and the calculated likelihood by a Bayes' calculator; sampling the latent variable from the final posterior distribution; and inferring test output data based on the sampled latent variable and test input data by an inference engine, wherein respective meta parameters of a neural network of the data distribution learner, the prior distribution of the latent variable of the Bayes' calculator, and a neural network of the inference engine are trained by a meta learning.

### CROSS-REFERENCE TO RELATED APPLICATIONS

This application claims priority to and the benefit of Korean Patent Application No. 10-2024-0103287 filed in the Korean Intellectual Property Office on Aug. 2, 2024, the entire contents of which are incorporated herein by reference.

### BACKGROUND

### 1. Field

The present disclosure relates to a method and device with Bayesian meta continual-learning and inference, and particularly, with the use of a Bayesian update scheme for a meta continual-learning.

### 2. Description of Related Art

Continual-learning involves learning non-stationary data whose statistical characteristics change continuously. Continual-learning data typically includes a training stream and test data. Learning data sequentially accessed as a stream and each accessed sample or is usually not be accessed again.

A continual-learning model evaluates performance on not only newly learned data but also previously learned data, and aims to achieve good performance on all continuously inflowing data simultaneously.

Previous continual-learning techniques have trained models using stochastic gradient descent. As new information is continuously overwritten on a previously learned model in order to learn new data, catastrophic forgetting can occur; performance on past data continuously declines as the learning progresses.

### SUMMARY

Described herein is a meta continual-learning and inferring method using Bayes' theorem for using a sequential Bayesian update scheme using a meta-learned data distribution learner and an inference engine.

A meta continual-learning and inferring method uses an implementation of Bayes' theorem for obtaining likelihood by a meta-learned data distribution learner, obtaining distribution of a latent variable according to a sequential Bayesian update by a Bayes' calculator, and performing inference based on the sampled latent variable by a meta-learned inference engine.

In one general aspect, method of meta continual-learning and inferring uses an implementation of Bayes' theorem, and the method includes: calculating a likelihood of learning data for a given latent variable by a data distribution learner; performing a sequential Bayesian update and calculating a final posterior distribution of the latent variable by using prior distribution of the latent variable and the calculated likelihood by a Bayes' calculator; sampling the latent variable from the final posterior distribution; and inferring test output data based on the sampled latent variable and test input data by an inference engine, wherein respective meta parameters of a neural network of the data distribution learner, the prior distribution of the latent variable of the Bayes' calculator, and a neural network of the inference engine are trained by a meta learning.

The performing of the sequential Bayesian update and the calculating of final posterior distribution of the latent variable may include expressing the prior distribution and the posterior distribution in an exponential family form during the sequential Bayesian update process.

The expressing of the prior distribution and the posterior distribution in an exponential family form may include using Gaussian distribution from among the exponential family.

The sampling of the latent variable from the final posterior distribution may include sampling the latent variable using a Monte Carlo (MC) approximator or a reparameterization trick.

The inferring of test output data based on the sampled latent variable and test input data may include inferring data distribution from the latent variable by a generative inference engine.

In another general aspect, a device for meta continual-learning and inferring uses an implementation of Bayes' theorem, and the apparatus includes: a data distribution learner for calculating likelihood of learning data for a given latent variable; a Bayes' calculator for performing a sequential Bayesian update and calculating a final posterior distribution of the latent variable by using prior distribution of the latent variable and the calculated likelihood; and an inference engine for inferring test output data based on a latent variable sampled from the final posterior distribution and test input data, wherein respective meta parameter of a neural network of the data distribution learner, the prior distribution of the latent variable of the Bayes' calculator, and a neural network of the inference engine are trained through a meta learning.

The device may further include a Monte Carlo (MC) approximator for sampling the latent variable from the final posterior distribution.

The device may include a first layer including the data distribution learner, the Bayes' calculator, the MC approximator, and the inference engine, the first layer performing sequential Bayesian update-based meta inference, and a second layer for performing meta learning on respective meta parameters of a neural network of the data distribution learner, prior distribution of the latent variable of the Bayes' calculator and a neural network of the inference engine.

The Bayes' calculator may express the prior distribution and the posterior distribution in an exponential family during the sequential Bayesian update process.

The inference engine may include a generative inference engine.

In another general aspect, a meta continual-learning and inferring method uses an implementation of Bayes' theorem, and the method includes: generating an episode for meta learning; inputting given learning data in the episode; calculating a likelihood of the learning data for a given latent variable by a data distribution learner; performing a sequential Bayesian update and calculating a final posterior distribution of the latent variable by using prior distribution of the latent variable and the calculated likelihood by a Bayes' calculator; sampling the latent variable from the final posterior distribution; inferring test output data based on the sampled latent variable and test input data by an inference engine; calculating a lower bound of an objective function for the test output data; and learning respective meta parameters of a neural network of the data distribution learner, prior distribution of the latent variable of the Bayes' calculator, and a neural network of the inference engine through meta learning by maximizing the lower bound of the objective function.

The performing of a sequential Bayesian update and calculating of final posterior distribution of the latent variable may include expressing the prior distribution and the posterior distribution in an exponential family form during the sequential Bayesian update process.

The expressing of the prior distribution and the posterior distribution in an exponential family form may include using Gaussian distribution from among the exponential family.

The sampling of the latent variable from the final posterior distribution may include sampling the latent variable using a Monte Carlo (MC) approximator or a reparameterization trick.

The calculating of a lower bound of an objective function for the test output data may include calculating the lower bound of the objective function for maximizing log-likelihood for the test output data based on the test input data and the learning data.

The inference engine may include a generative inference engine.

The meta continual learning and inferring method using the Bayes' theorem according to the embodiment may increase mean accuracy performance of the meta continual learning and may increase the operation/memory efficiency.

Other features and aspects will be apparent from the following detailed description, the drawings, and the claims

### BRIEF DESCRIPTION OF THE DRAWINGS

FIG. 1 shows a meta continual-learning and inference device using Bayes' theorem according to one or more embodiments.

FIG. 2 shows a meta continual-learning and inference device using Bayes' theorem according to one or more embodiments.

FIG. 3 shows a meta continual-learning and inference device using Bayes' theorem according to one or more embodiments.

FIG. 4 to FIG. 6 show a meta continual-learning and inference method using Bayes' theorem according to one or more embodiments.

FIG. 7 shows a computing device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

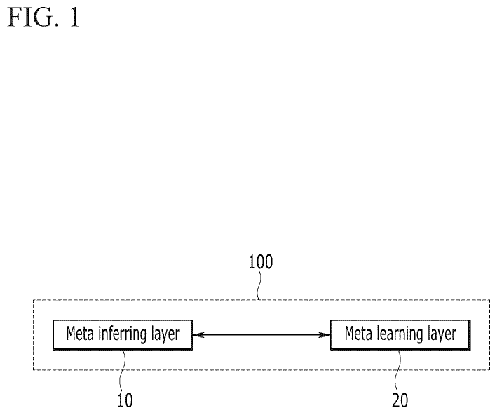

FIG. 1 shows a meta continual-learning and inference device using Bayes' theorem according to one or more embodiments.

Referring to FIG. 1, the meta continual-learning and inference device 100 (hereafter, “device 100”) using Bayes' theorem may include a meta inferring layer 10 and a meta learning layer 20.

The device 100 may be applied to cases where learning an inference model is to maintain excellent performance while learning data whose distribution changes.

That is, the device 100 may continuously perform meta learning on a continual-learning model and a neural network used in the meta inferring layer 10, in the meta learning layer 20.

Therefore, the device 100 may learn a model that works effectively in situations where the samples of learning data for a new data distribution are limited (e.g., data for few-shot learning).

For example, the meta inferring layer 10 may be provided through an inner loop in the device 100.

The meta learning layer 20 may be provided through an outer loop in the device 100.

That is, the device 100 may perform a meta learning for the continual-learning model in the outer loop during the process for performing a Bayesian update-based continual-learning and inference in the inner loop.

The device 100 may perform a sequential Bayesian update-based meta inference by using (i) the neural network of the data distribution learner in the meta inferring layer 10, (ii) distribution of latent variables of a Bayes' calculator, and (iii) the neural network of an inference engine.

The device 100 may learn (i) meta parameters of the neural network of the data distribution learner, (ii) prior distribution of the latent variable of the Bayes' calculator, and (iii) the respective neural networks of the inference engine through the meta learning on the meta learning layer 20.

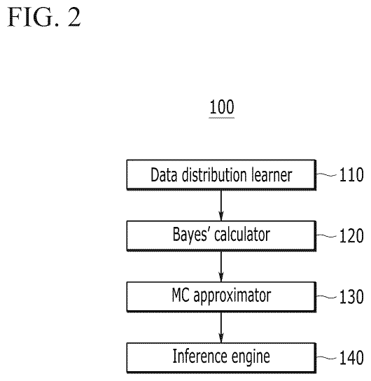

FIG. 2 shows a block diagram of a meta continual-learning and inference device using Bayes' theorem according to one or more embodiments.

Referring to FIG. 2, device 100 may include a data distribution learner 110, a Bayes' calculator 120, a Monte Carlo (MC) approximator 130, and an inference engine 140.

The data distribution learner 110 may calculate the likelihood of the training data for a given latent variable.

The Bayes' calculator 120 may perform sequential Bayesian updates using the prior distribution of latent variables and the calculated likelihood.

Bayes' theorem is a mathematical formula for processing a conditional probability, and may provide a method for calculating posterior distribution using prior distribution and a new evidence.

The Bayes' calculator 120 may calculate final posterior distribution of latent variables through the sequential Bayesian update.

The sequential Bayesian update may be a process of updating the posterior distribution by repeatedly applying Bayes' theorem when the data arrive sequentially.

The Bayes' calculator 120 may express the prior distribution and posterior distribution in the form of an exponential family during the sequential Bayesian update process.

The Bayes' calculator 120 models the prior distribution and the posterior distribution used in the sequential Bayesian update in the form of an exponential family. By this, the Bayesian update may be efficiently performed without loss of information.

The exponential family refers to specific types of probability distributions that may be expressed in the form of an exponential function. A representative example of this is the Gaussian distribution.

The MC approximator 130 may sample latent variables from the final posterior distribution.

The inference engine 140 may infer test output data based on the sampled latent variables and test input data from the final posterior distribution.

For example, the inference engine 140 may include a generative inference engine. The generative inference engine may be a model configured to generate new data from given data and/or configured to learn the distribution of data to make inferences.

To learn the generative model, the data distribution learner 110 is configured as a neural network for obtaining a likelihood q_{ϕ}(xₜ|z) from a given data sample xₜ, and the generative inference engine 140 is configured as a neural network for inferring the data distribution p_{θ}(xₙ|z) from the latent variable.

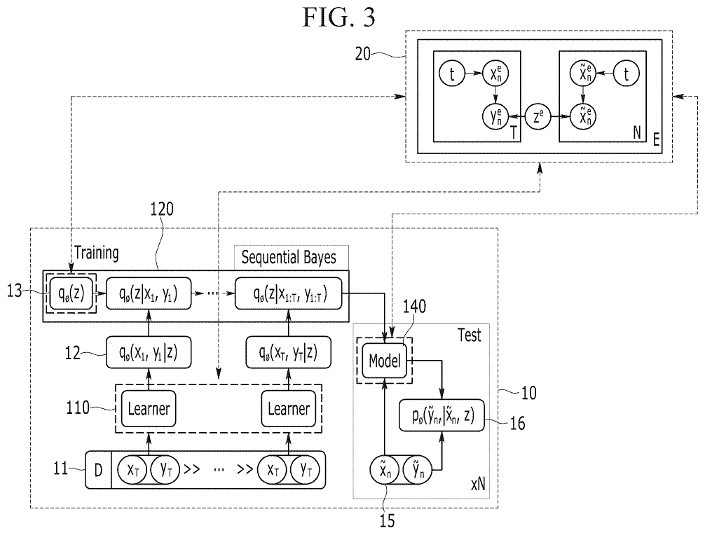

FIG. 3 shows a diagram of a meta continual-learning and inference device using the Bayes' theorem according to one or more embodiments.

Referring to FIG. 3, the data distribution learner (or learner) 110 includes a neural network for obtaining the likelihood 12 q_{ϕ}(xₜ, yₜ|z) from the given learning data D (x₁, y₁ to X_{T}, and y_{T}) 11. The neural network may be learned through the meta learning.

The Bayes' calculator (or sequential Bayes) 120 may perform the sequential Bayesian update using the prior distribution q_{ϕ}(z) 12 of the latent variable and the likelihood q_{ϕ}(xₜ, yₜ|z) 12 of the learning data. The parameter q_{ϕ}(z) of the prior distribution may be learned through the meta learning.

The parameter q_{ϕ}(z| [symbol] ) for determining the distribution of the latent variable using the learning data may be expressed as Equation 1 by using the sequential Bayesian update.

$${q}_{ϕ} ( z \vert {x}_{1 : t} , {y}_{1 : t} ) ∝ {q}_{ϕ} ( {x}_{t} , {y}_{t} \vert z ) {q}_{ϕ} ( z \vert {x}_{1 : t - 1} , {y}_{1 : t - 1} ) {q}_{ϕ} ( z \vert {x}_{1} , {y}_{1} ) ∝ {q}_{ϕ} ( {x}_{1} , {t}_{1} \vert z ) {q}_{ϕ} ( z ) \qquad Equation 1$$

Here, q_{ϕ}(z) is the prior probability distribution of the latent variable, q_{ϕ}(xₜ, yₜ|z) is the likelihood of the learning data (or data sample) when the latent variable z is given, and q_{ϕ}(z|x_{1:t}, y_{1:t})=q_{ϕ}(z| [symbol] ) is the posterior probability distribution of the latent variable when the learning data of 1 to t are given.

That is, the posterior distribution q_{ϕ}(z| [symbol] ) may be obtained according to a simple operation when q_{ϕ}(z) (which corresponds to the prior distribution of variational distribution) and q_{ϕ}(xₜ, yₜ|z) (which is the likelihood on the respective learning data) are obtained.

The MC approximator (not shown) may sample the latent variable z from the final posterior distribution q_{ϕ}(z|x_{1:T}, y_{1:T}) 14 obtained by the Bayes' calculator 120. That is, the latent variable expressed as probability distribution may be sampled through the MC approximator and may be provided as a specific value.

A reparameterization trick may be used in sampling the latent variable.

The inference engine (or model) 140 includes a neural network for inferring p_{θ}(\tilde{y}ₙ|\tilde{x}ₙ, z) from the latent variable z and the test input data 15. The neural network may be learned through the meta learning.

As described, the device 100 (see FIG. 1) may perform training using the data distribution learner 110, the Bayes' calculator 120, and the MC approximator and may perform a test using the inference engine 140 on the meta inferring layer 10.

The device 100 may meta-learn the neural network parameter of the data distribution learner 110, the parameter of the prior probability distribution of the Bayes' calculator 120, and the neural network parameter of the inference engine 140 from the meta learning layer 20.

The meta continual-learning may meta-learn the continual-learning algorithm.

Regarding the meta continual-learning process through the device 100, the t-th data may be expressed as

$$( {x}_{t}^{e} , {t}_{t}^{es} ) and ( {\tilde{x}}_{n}^{e} , {\tilde{y}}_{n}^{e} )$$

when the episode e is given as T-numbered training streams and N-numbered test data (or test sets) from among E-numbered continual-learning episodes.

When the episode latent variable is given as z^{e}, output values of the learning data and the test data are determined by the input data and the latent variable.

Here, e represents the episode and is a learning unit of the meta learning. Each episode includes learning data and inference data. The meta learning undergoes the learning/inference/meta update process for each episode.

As noted, z is the latent variable. When the model learns the weather of each month, the latent variable may include internal variables for predicting the weathers.

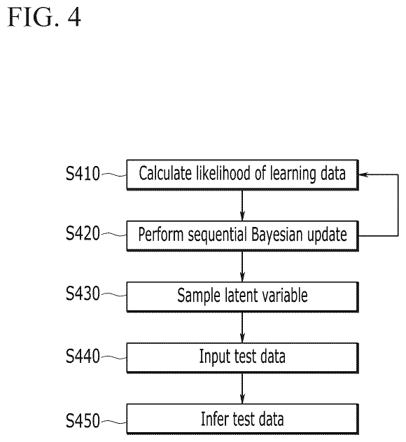

FIG. 4 to FIG. 6 show flowchart of a meta continual-learning and inference method using Bayes' theorem according to one or more embodiments.

The meta continual-learning and inferring method using Bayes' theorem of FIG. 4 to FIG. 6 may be performed by the device 100 of FIG. 1.

FIG. 4 shows a flowchart of a meta inference process using a Bayesian principle, according to one or more embodiments. That is, FIG. 4 shows a method for a meta-learned model to be operable in an inference process.

The device 100 may learn the data distribution learner, the neural network parameter of the inference engine, and the prior distribution of the Bayes' calculator through the meta learning, and may use them during the inference process.

The meta inference process of FIG. 4 transmits information of learning data according to the Bayesian principle, which differs from the general stochastic gradient descent (SGD)-based model, substantially reducing the amount of operations and the amount of use of memories.

Referring to FIG. 4, the device 100 may calculate the likelihood of learning data for the given latent variable by the data distribution learner (S410).

The device 100 may perform the sequential Bayesian update using prior distribution of the latent variable and the calculated likelihood by the Bayes' calculator, and may calculate final posterior distribution of the latent variable (S420).

The device 100 may express prior distribution and posterior distribution in the form of exponential family during the sequential Bayesian update process. For example, the device 100 may use Gaussian distribution in the exponential family.

The device 100 may sample the latent variable from the final posterior distribution (S430).

The device 100 may sample the latent variable using the MC approximator or the reparameterization trick. The latent variable is obtained as a specific value used in inference through the sampling.

The device 100 may input test data (S440).

The device 100 may then infer, by the inference engine, test output data based on the sampled latent variable and based on the test input data (S450).

That is, the device 100 may generate a latent variable instead of the parameter to be used in the inference engine by the continual-learning.

The device 100 may perform a test based on the latent variable by the meta-learned inference engine.

That is, the respective meta parameters of the neural network of the data distribution learner, prior distribution of the latent variable of the Bayes' calculator, and the neural network of the inference engine may be learned through the meta learning.

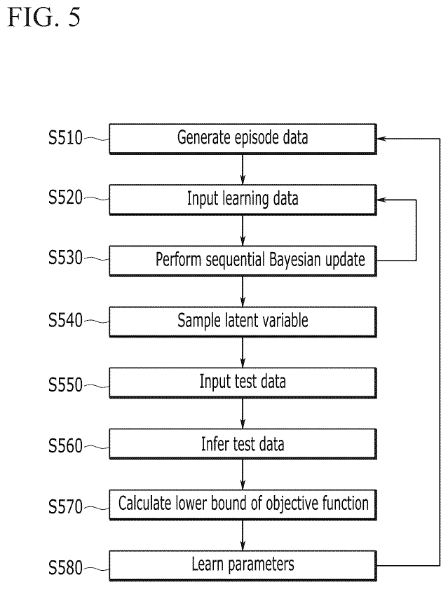

FIG. 5 shows a flowchart of a meta continual-learning process, according to one or more embodiments.

Referring to FIG. 5, the device 100 using may generate episode data for the meta learning (S510).

The device 100 may input the learning data from among episode data (S520).

The device 100 may calculate the likelihood of the learning data for the given latent variable by the data distribution learner.

The device 100 may perform a sequential Bayesian update using the prior distribution of the latent variable and calculated likelihood by the Bayes' calculator and may calculate the final posterior distribution of the latent variable (S530).

The device 100 may repeatedly perform the Bayesian update for the sequentially given learning data.

The device 100 may sample the latent variable from the final posterior distribution (S540).

The device 100 may input the test input data (S550).

The device 100 may infer the test output data based on the sampled latent variable and the test input data by the inference engine (S560).

That is, the device 100 may infer the test output data expressed as a probability distribution.

The device 100 may calculate a lower bound of an objective function for the test output data (S570).

The device 100 may calculate the lower bound for the objective function maximizing the log-likelihood of the meta continual-learning by using Equation 2.

$$log {p}_{θ} ( {\tilde{y}}_{1 : N} \vert {\tilde{x}}_{1 : N} , D ) = log {p}_{θ} ( {\tilde{y}}_{1 : N} \vert {\tilde{x}}_{1 N :} , {x}_{1 : T} , {y}_{1 : T} ) \geq {𝔼}_{z - {q}_{ϕ} ( z \vert D )} [ {\sum }_{n = 1}^{N} log {p}_{θ} ( {\tilde{y}}_{n} \vert {\tilde{x}}_{n} , z ) + {\sum }_{t = 1}^{T} log {p}_{θ} ( {y}_{t} \vert {x}_{t} , z ) ] - {D}_{KL} ( {q}_{ϕ} ( z \vert D ) ‖ {p}_{θ} ( z ) ) - log {p}_{θ} ( D ) \qquad Equation 2$$

Here,
(1) log p_{θ}(\tilde{y}_{1:N}|\tilde{x}_{1:N}, [symbol] ) is the likelihood of output values of the inference data (or test data) of 1 to N when input values of the inference data (or test data) of 1 to N and the learning data (D) are given,
(2) [symbol] _{z˜q}_{_{ϕ}}(z| [symbol] ) [·] is the sum of the likelihood of inference data and the likelihood of learning data when the latent variable z obtained from the posterior distribution (q_{ϕ}(z| [symbol] ) is given,
(3) D_{KL}(q_{ϕ}(z| [symbol] )∥p_{θ}(z))₍ᵢ₎ is calculated to show accuracy of the variational distribution q_{ϕ}(z| [symbol] ) that is an approximate value of the probability distribution of the latent variable expresses p_{θ}(z) that is the actual probability of the latent variable (ii) by using KL-divergence for measuring a distance between the probability distributions, and
(4) log p_{θ}( [symbol] ) is the likelihood of learning data. The learning data are given values and are provided as constants that do not influence the learning.

The meta continual-learning and inferring device 100 may calculate the lower bound of the log-likelihood using Equation 2 and may update the meta parameter by maximizing the lower bound during the meta learning process.

The meta continual-learning and inferring device 100 may learn the respective meta parameters of the neural network of the data distribution learner, the prior distribution of the latent variable of the Bayes' calculator, and the neural network of the inference engine through the meta learning by maximizing the lower bound of the objective function (S580).

The device 100 may repeatedly perform the above-described meta learning process using new episodes.

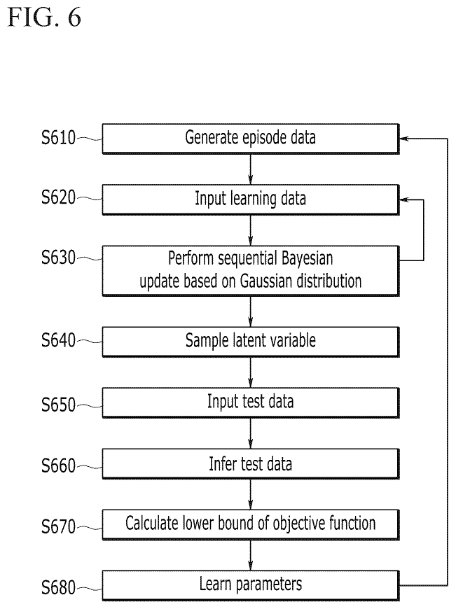

FIG. 6 shows a Gaussian distribution-based meta continual-learning process, according to one or more embodiments. That is, FIG. 6 shows a process for sequentially performing Bayesian updates based on the Gaussian distribution. The description of steps S510, S520, and S540 to S580 is generally applicable to steps S610, S620, and S640 to S680, respectively.

Referring to FIG. 6, the meta continual-learning and inferring device 100 uses the exponential family for the prior distribution and the posterior distribution of the Bayesian update process.

The device 100 may use Gaussian distribution from the exponential family (S630).

The meta continual-learning and inferring device 100 may model the prior distribution as [symbol] (z; μ₀, Λ₀⁻¹) and the posterior distribution as [symbol] (z; μ₀, Λₜ⁻¹) by using the Gaussian distribution [symbol] .

When the output of the Bayes' calculator 120 (see FIG. 2) represents noisy observation (\tilde{z}ₜ) of the latent variable and precision (Pt) of the Gaussian distribution, the likelihood may be modeled as expressed in Equation 3.

$${q}_{ϕ} ( {x}_{t} , {y}_{x} \vert z ) = ( {\hat{z}}_{t} ; z , {P}_{t}^{- 1} ) \qquad Equation3$$

Here, q_{ϕ}(xₜ, yₓ|z) is the likelihood of learning data (or data sample) when the latent variable is given.

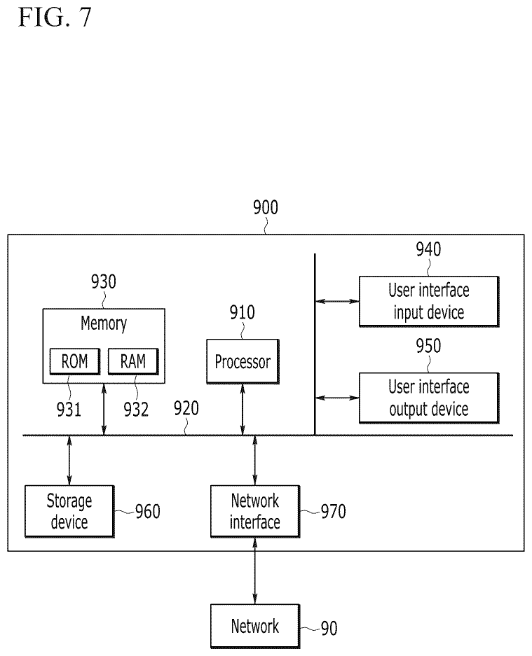

FIG. 7 shows a computing device according to one or more embodiments.

Referring to FIG. 7, the meta continual-learning and the inference method, and the device according to the embodiments may be realized using the computing device 900.

The computing device 900 may include a processor 910, a memory 930, a user interface input device 940, a user interface output device 950 and a storage device 560 communicating through a bus 920. The computing device 900 may also include a network interface 970 electrically connected to a network 90. The network interface 970 may transmit or receive signals to/from another entity through the network 90.

The processor 910 may be implemented in various types, such as a micro controller unit (MCU), an application processor (AP), a central processing unit (CPU), a graphic processing unit (GPU), a neural processing unit (NPU), and/or the like, and may be a predetermined semiconductor device executing commands stored in the memory 930 or the storage device 960. The processor 910 may be configured to implement the function and the method described above with reference to FIG. 1 to FIG. 6.

The memory 930 and the storage device 960 may include various types of volatile or nonvolatile storage media. For example, the memory may include a read only memory (ROM) 931 and a random access memory (RAM) 932. In the present embodiment, the memory 930 may be disposed inside or outside the processor 910, and the memory 930 may be connected with the processor 910 through known various types of means.

In some embodiments, at least some of the components or functions from among the meta continual-learning and inferring method and device using the Bayes' theorem may be implemented as a program or software (in the form of instructions) running on the computing device 900, and the program or software may be stored in a computer-readable medium.

In some embodiments, at least some of the components or functions from among the meta continual-learning and inferring method and device may be implemented using hardware or circuits of the computing device 900 or may be implemented as hardware or circuit electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

The computing apparatuses, the electronic devices, the processors, the memories, the information output system and hardware, the storage devices, and other apparatuses, devices, units, modules, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of meta continual-learning and inferring using an implementation of Bayes' theorem, the method comprising:
calculating a likelihood of learning data for a given latent variable by a data distribution learner;
performing a sequential Bayesian update and determining a final posterior distribution of the latent variable based on prior distribution of the latent variable and the calculated likelihood;
sampling the latent variable from the final posterior distribution; and
inferring, by a model, test output data based on the sampled latent variable and test input data,
wherein respective meta parameters of a neural network of the data distribution learner, the prior distribution of the latent variable, and a neural network of the inference engine are trained by a meta learning.

2. The method of claim 1, wherein
the performing of the sequential Bayesian update and the determining of the final posterior distribution of the latent variable includes
expressing the prior distribution and the posterior distribution in an exponential family form during the sequential Bayesian update process.

3. The method of claim 2, wherein
the expressing of the prior distribution and the posterior distribution in an exponential family form includes
using Gaussian distribution from among the exponential family.

4. The method of claim 1, wherein
the sampling of the latent variable from the final posterior distribution includes
sampling the latent variable using a Monte Carlo (MC) approximator or a reparameterization trick.

5. The method of claim 1, wherein
the inferring of test output data based on the sampled latent variable and test input data includes
inferring data distribution from the latent variable by a generative inference engine.

6. An apparatus for meta continual-learning and inferring using an implementation of Bayes' theorem, the apparatus comprising:
a data distribution learner for calculating likelihood of learning data for a given latent variable;
a Bayes' calculator for performing a sequential Bayesian update and determining a final posterior distribution of the latent variable by using prior distribution of the latent variable and the calculated likelihood; and
an inference engine for inferring test output data based on a latent variable sampled from the final posterior distribution and test input data,
wherein respective meta parameter of a neural network of the data distribution learner, the prior distribution of the latent variable of the Bayes' calculator, and a neural network of the inference engine are trained by a meta learning.

7. The apparatus of claim 6, further comprising
a Monte Carlo (MC) approximator for sampling the latent variable from the final posterior distribution.

8. The apparatus of claim 7, further comprising
a first layer including the data distribution learner, the Bayes' calculator, the MC approximator, and the inference engine, the first layer performing sequential Bayesian update-based meta inference, and
a second layer for performing meta learning on respective meta parameters of a neural network of the data distribution learner, prior distribution of the latent variable of the Bayes' calculator and a neural network of the inference engine.

9. The apparatus of claim 6, wherein
the Bayes' calculator expresses the prior distribution and the posterior distribution in an exponential family during the sequential Bayesian update process.

10. The apparatus of claim 6, wherein
the inference engine includes a generative inference engine.

11. A method of meta continual-learning and inferring method using an implementation of Bayes' theorem, the method comprising:
generating an episode for meta learning;
inputting given learning data in the episode;
calculating a likelihood of the learning data for a given latent variable by a data distribution learner;
performing a sequential Bayesian update and determining a final posterior distribution of the latent variable based on prior distribution of the latent variable and the calculated likelihood;
sampling the latent variable from the final posterior distribution;
inferring, by a model, test output data based on the sampled latent variable and test input data;
calculating a lower bound of an objective function for the test output data; and
learning respective meta parameters of a neural network of the data distribution learner, prior distribution of the latent variable of the Bayes' calculator, and a neural network of the inference engine through meta learning by maximizing the lower bound of the objective function.

12. The method of claim 11, wherein
the performing of a sequential Bayesian update and the determining of the final posterior distribution of the latent variable includes
expressing the prior distribution and the posterior distribution in an exponential family form during the sequential Bayesian update process.

13. The method of claim 12, wherein
the expressing of the prior distribution and the posterior distribution in an exponential family form includes
using Gaussian distribution from among the exponential family.

14. The method of claim 11, wherein
the sampling of the latent variable from the final posterior distribution includes
sampling the latent variable using a Monte Carlo (MC) approximator or a reparameterization trick.

15. The method of claim 11, wherein
the calculating of a lower bound of an objective function for the test output data includes
calculating the lower bound of the objective function for maximizing log-likelihood for the test output data based on the test input data and the learning data.

16. The method of claim 11, wherein
the inference engine includes a generative inference engine.
